(19) United States
(12) Patent Application Publication
(10) Pub. No.: US 2014/0358468 A1
(43) Pub. Date: Dec. 4, 2014

(54) APPARATUS FOR AUTOMATICALLY ARRANGING SENSORS AND METERS BASED ON BUILDING INFORMATION MODELING

(71) Applicant: Electronics and Telecommunications Research Institute, Daejeon (KR)

(72) Inventors: Jong Won KIM, Daejeon (KR); Youn Kwae JEONG, Daejeon (KR); Il Woo LEE, Daejeon (KR)

(73) Assignee: Electronics and Telecommunications Research Institute, Daejeon (KR)

(21) Appl. No.: 14/148,152

(22) Filed: Jan. 6, 2014

(30) Foreign Application Priority Data
Jun. 4, 2013 (KR) 10-2013-0064095

(51) Int. Cl. G01D 21/00

(52) U.S. Cl. CPC G01D 21/00
USPC 702/127

(57) ABSTRACT

A apparatus includes a function of automatically arranging various sensors, such as temperature, humidity, illumination, presence, and CO₂, and various meters, such a power and gas, in the rooms, floors, and buildings of a building model based on BIM by arranging the various sensors according to an optimum arrangement, an installation cost-based arrangement, or a user-based arrangement and arranging the various meters based on an optimum arrangement and of displaying the arranging sensors and meters in a 3-D space, a function of displaying the arrangement coordinates of various sensors and various meters, and a function of calculating and displaying the number of arranged sensors and meters and a cost for the arranged sensors and meters.

### RELATED APPLICATIONS(S)

This application claims the benefit of Korean Patent Application No. 10-2013-0064095, filed on Jun. 4, 2013, which is hereby incorporated by references as if fully set forth herein.

### FIELD OF THE INVENTION

The present invention relates to a scheme for automatically arranging various sensors and meters within a building and, more particularly, to an apparatus for automatically arranging sensors and meters based on Building Information Modeling (BIM), which are suitable for automatically arranging various sensors and meters necessary to manage building energy and environments in the rooms, floors, and buildings of a building model based on BIM by arranging the various sensors according to an optimum arrangement, an installation cost-based arrangement, or a user-based arrangements and arranging the various meters according to an optimum arrangement.

### BACKGROUND OF THE INVENTION

A prior art includes a wireless sensor network modeling system for performing modeling by taking a 3-D space in which a sensor node, a gateway, and a server are actually disposed and communication obstacles placed in the space into consideration.

In general, a wireless sensor network system is configured using a sensor node capable of wireless communication, a gateway for performing data communication with the sensor node, a server for determining a change of an environment based on information obtained from the gateway and taking corresponding measures, etc. are necessary.

Furthermore, in order to develop a wireless sensor network system using a sensor node, reference is made to coverage, an installation location, etc. of the sensor node through modeling for the wireless sensor network system. A conventional wireless sensor network modeling system allows only a sensor node, a gateway, and a server, limited to only a wireless sensor network, to be disposed, but does not provide functions, such as an optimum arrangement, an installation cost-based arrangement, and a user-based arrangements based on BIM in relation to various sensors and meters.

### SUMMARY OF THE INVENTION

In view of the above, the present invention provides a scheme for automatically arranging sensors and meters based on BIM, which capable of providing a function of automatically arranging various sensors, such as temperature, humidity, illumination, presence, and CO₂, and various meters, such a power and gas, in the rooms, floors, and buildings of a building model based on BIM by arranging the various sensors according to an optimum arrangement, an installation cost-based arrangement, or a user-based arrangement and arranging the various meters based on an optimum arrangement and of displaying the arranging sensors and meters in a 3-D space, a function of displaying the arrangement coordinates of various sensors and various meters, and a function of calculating and displaying the number of arranged sensors and meters and a cost for the arranged sensors and meters.

In accordance with an aspect of the present invention, there is provided an apparatus for automatically arranging sensors and meters based on Building Information Modeling(BIM), which includes a user interface block for transferring option information and input information for simulations related to an arrangement of various sensors and various meters to a sensor/meter automatic-arrangement block and for displaying information about a simulation progress state and arrangement-related information, received from the sensor/meter automatic-arrangement block, on a screen, the sensor/meter automatic-arrangement block for generating the information about the simulation progress state by generating optimum arrangement coordinates, installation cost-based arrangement coordinates, and user-based arrangement coordinates for the various sensors and optimum arrangement coordinates for the various meters, generating arrangement coordinates of respective arrangement places of the various sensors, arrangement coordinates of respective arrangement places of the various meters, and a 3-D screen view signal, transferring the arrangement coordinates of the arrangement places of the various sensors and the various meters and the 3-D screen view signal to a BIM-based building model block, calculating a number of arranged sensors and meters and a cost for the arranged sensors and meters, and transferring the calculated number and cost to the user interface block, and the BIM-based building model block for automatically arranging the various sensors and the various meters in corresponding places of a building based on the received arrangement coordinates of the respective arrangement places of the various sensors, the arrangement coordinates of the respective arrangement places of the various meters, and the 3-D screen view signal, displaying a sensor/meter arrangement 3-D screen in a building model based on BIM, and transferring building space information to the sensor/meter automatic-arrangement block.

In the exemplary embodiment, the user interface block may include a sensor/meter arrangement user interface unit for receiving option information about arrangement places and methods for the various sensors, transferring the received option information about the arrangement places and methods for the various sensors to the sensor/meter automatic-arrangement block, receiving option information about arrangement places and methods for the various meters, and transferring the option information about the arrangement places and methods for the various meters to the sensor/meter automatic-arrangement block, an arrangement simulation user interface unit for receiving simulation start option information, transferring the simulation start option information to the sensor/meter automatic-arrangement block, and displaying the information about the simulation progress state on a screen, and an arrangement result display user interface unit for receiving information about a unit cost of each of the various sensors and the various meters, transferring the information about the unit cost to the sensor/meter automatic-arrangement block, transferring an arrangement number and cost calculation view signal, an arrangement result view signal, and a 3-D screen view selection signal to the sensor/meter automatic-arrangement block when arrangement result display method option information is received, and displaying the information about the number of arranged sensors and meters, the cost for the arranged sensors and meters, the arrangement coordinates of the respective arrangement places of the various sensors, and the arrangement coordinates of the respective arrangement places of the various meters to the sensor/meter automatic-arrangement block.

In the exemplary embodiment, the sensor/meter automatic-arrangement block may include a sensor optimum-arrangement unit for generating the optimum arrangement coordinates for the various sensors by performing an optimum arrangement on the various sensors in response to the information about the arrangement places and methods for the various sensors and the simulation start signal, a sensor installation cost-based arrangement unit for generating the installation cost-based arrangement coordinates for the various sensors by performing an installation cost-based arrangement on the various sensors in response to the information about the arrangement places and methods for the various sensors and the simulation start signal, a sensor user-based arrangement unit for generating the user-based arrangement coordinates for the various sensors by performing a user-based arrangement on the various sensors in response to the information about the arrangement places and methods for the various sensors and the simulation start signal, a meter optimum-arrangement unit for generating optimum arrangement coordinates for the various meters by performing an optimum arrangement on the various meters in response to the information about the arrangement places and methods for the various meters and the simulation start signal, and a sensor/meter automatic-arrangement central processing unit for generating the information about the simulation progress state based on the optimum arrangement coordinates, the installation cost-based arrangement coordinates, and the user-based arrangement coordinates for the various sensors and the optimum arrangement coordinates for the various meters, transferring the generated information about the simulation progress state to the user interface block, transferring the arrangement coordinates of the respective arrangement places of the various sensors and the arrangement coordinates of the respective arrangement places of the various meters to the user interface block and the BIM-based building model block, calculating the number of arranged sensors and meters and the cost for the arranged sensors and meters, transferring the calculated number and cost to the user interface block, generating the 3-D screen view signal, transferring the generated 3-D screen view signal to the BIM-based building model block, and receiving the building space information from the BIM-based building model block.

In the exemplary embodiment, the various sensors and the various meters may include a plurality of sensors and a plurality of meters for managing building energy and environments.

In the exemplary embodiment, the various sensors may include a temperature sensor, a humidity sensor, an illumination sensor, a presence sensor, and a CO₂ sensor.

In the exemplary embodiment, the various meters may include a power meter and a gas meter.

### BRIEF DESCRIPTION OF THE DRAWINGS

The objects and features of the present invention will become apparent from the following description of embodiments given in conjunction with the accompanying drawings, in which:

FIGS. 1A and 1B are a block diagram of an apparatus for automatically arranging sensors and meters based on BIM in accordance with an embodiment of the present invention;

FIG. 2 is a detailed block diagram of a user interface block shown in FIG. 1; and

FIGS. 3A and 3B are a detailed block diagram of a sensor/meter automatic-arrangement block shown in FIG. 1.

### DETAILED DESCRIPTION OF THE EMBODIMENTS

First, the merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to understand the scope of the present invention. The present invention is defined by the claims.

In describing the embodiments of the present invention, a detailed description of known functions or constructions related to the present invention will be omitted if it is deemed that such description would make the gist of the present invention unnecessarily vague. Furthermore, terms to be described later are defined by taking the functions of embodiments of the present invention into consideration, and may be different according to the operator's intention or usage. Accordingly, the terms should be defined based on the overall contents of the specification.

Hereinafter, embodiments of the present invention will be described in detail with reference to the accompanying drawings which form a part hereof.

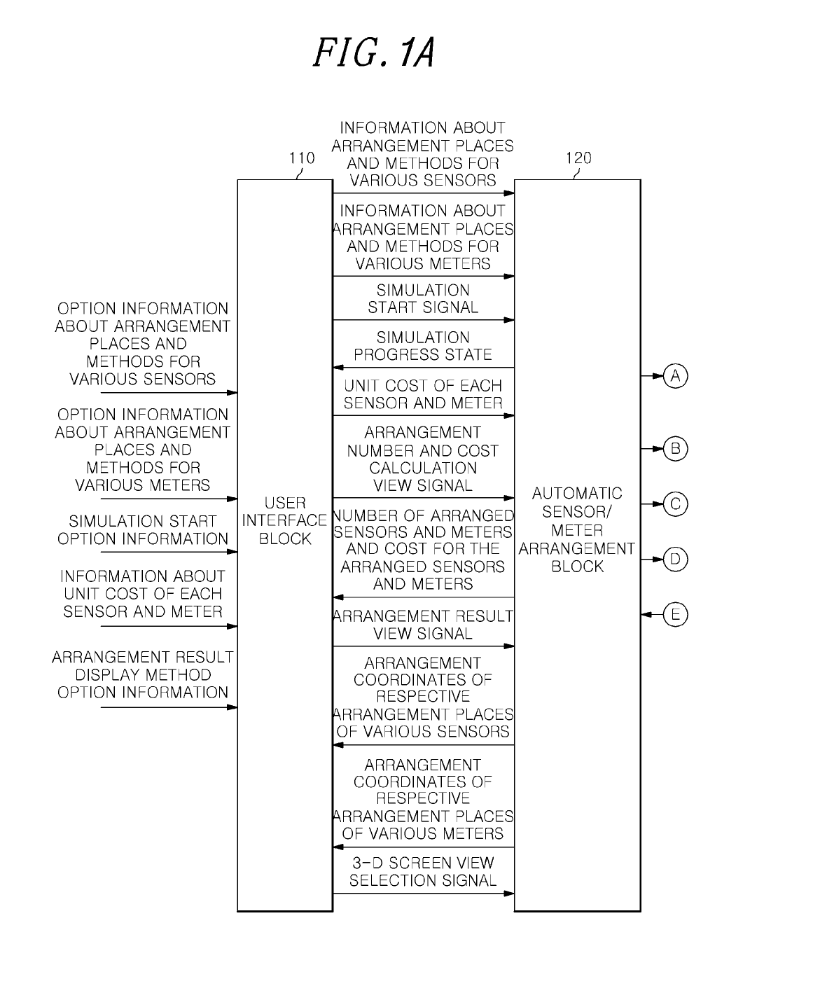

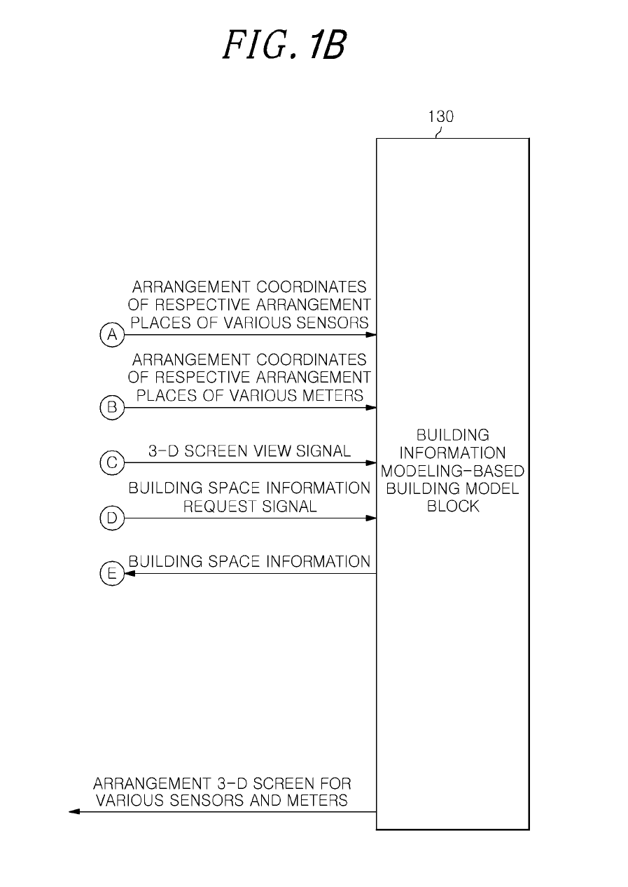

FIGS. 1A and 1B are a block diagram of an apparatus for automatically arranging sensors and meters based on BIM in accordance with an embodiment of the present invention. The apparatus may include a user interface block 110, a sensor/meter automatic-arrangement block 120, and a BIM-based building model block 130.

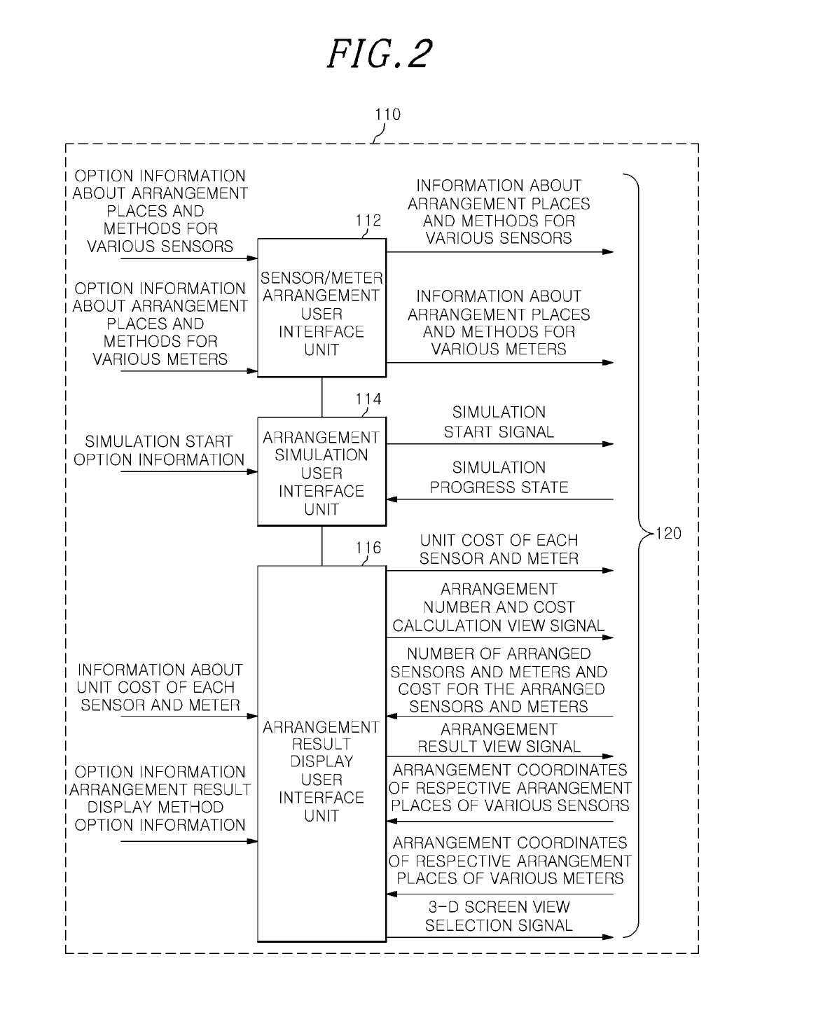

Referring to FIGS. 1A and 1B, the user interface block 110 can provide a function of transferring option information and input information necessary for simulations related to the arrangement of various sensors and various meters to the sensor/meter automatic-arrangement block 120 and displaying information about the simulation progress state and arrangement-related information received from the sensor/meter automatic-arrangement block 120 on a screen. To this end, the user interface block 110 may have elements shown in FIG. 2. Various sensors necessary to manage building energy and environments may include, for example, a temperature sensor, a humidity sensor, an illumination sensor, a presence sensor, a CO₂ sensor, and various meters necessary to manage building energy and environments may include, for example, a power meter and a gas meter.

FIG. 2 is a detailed block diagram of the user interface block 110 shown in FIG. 1. The user interface block 110 may include a sensor/meter arrangement user interface unit 112, an arrangement simulation user interface unit 114, and an arrangement result display user interface unit 116.

Referring to FIG. 2, the sensor/meter arrangement user interface unit 112 can provide a function of transferring option information about arrangement places and methods for various sensors to the sensor/meter automatic-arrangement block 120 when the option information is received from input means (not shown) and transferring option information about arrangement places and methods for various meters to the sensor/meter automatic-arrangement block 120 when the option information is received from input means (not shown).

The arrangement simulation user interface unit 114 can provide a function of generating a simulation start signal when simulation start option information is received from input means (not shown), transferring the simulation start signal to the sensor/meter automatic-arrangement block 120, and displaying a simulation progress state on a screen (not shown) when the simulation progress state is received from the sensor/meter automatic-arrangement block 120.

The arrangement result display user interface unit 116 can provide a function of transferring information about the unit cost of each of various sensors and meters to the sensor/meter automatic-arrangement block 120 when the information about the unit cost is received from input means (not shown), generating an arrangement number and cost calculation view signal, an arrangement result view signal, and a 3-D screen view selection signal when option information about an arrangement result display method is received, transferring the arrangement number and cost calculation view signal, the arrangement result view signal, and the 3-D screen view selection signal to the sensor/meter automatic-arrangement block 120, displaying information about the number of arranged sensors and meters and a cost for the arranged sensors and meters on a screen when the information about the number of arranged sensors and meters and the cost for the arranged sensors and meters is received from the sensor/meter automatic-arrangement block 120, and displaying the arrangement coordinates of the respective arrangement places of the various sensors and the arrangement coordinates of the respective arrangement places of the various meters on a screen when the arrangement coordinates of the respective arrangement places of the various sensors and the arrangement coordinates of the respective arrangement places of the various meters are received from the sensor/meter automatic-arrangement block 120.

Referring back to FIGS. 1A and 1B, the sensor/meter automatic-arrangement block 120 can provide a function of generating information about the simulation progress state by generating optimum arrangement coordinates, installation cost-based arrangement coordinates, and user-based arrangement coordinates for various sensors and optimum arrangement coordinates for various meters, generating the arrangement coordinates of the respective arrangement places of the various sensors, the arrangement coordinates of the respective arrangement places of the various meters, and a 3-D screen view signal, transferring the arrangement coordinates of the respective arrangement places of the various sensors, the arrangement coordinates of the respective arrangement places the various meters, and the 3-D screen view signal to the BIM-based building model block 130, calculating the number of sensors and meters that are arranged and cost for the arranged sensors and meters, and transferring the calculated number and cost to the user interface block 110. To this end, the sensor/meter automatic-arrangement block 120 may have elements shown in FIG. 2.

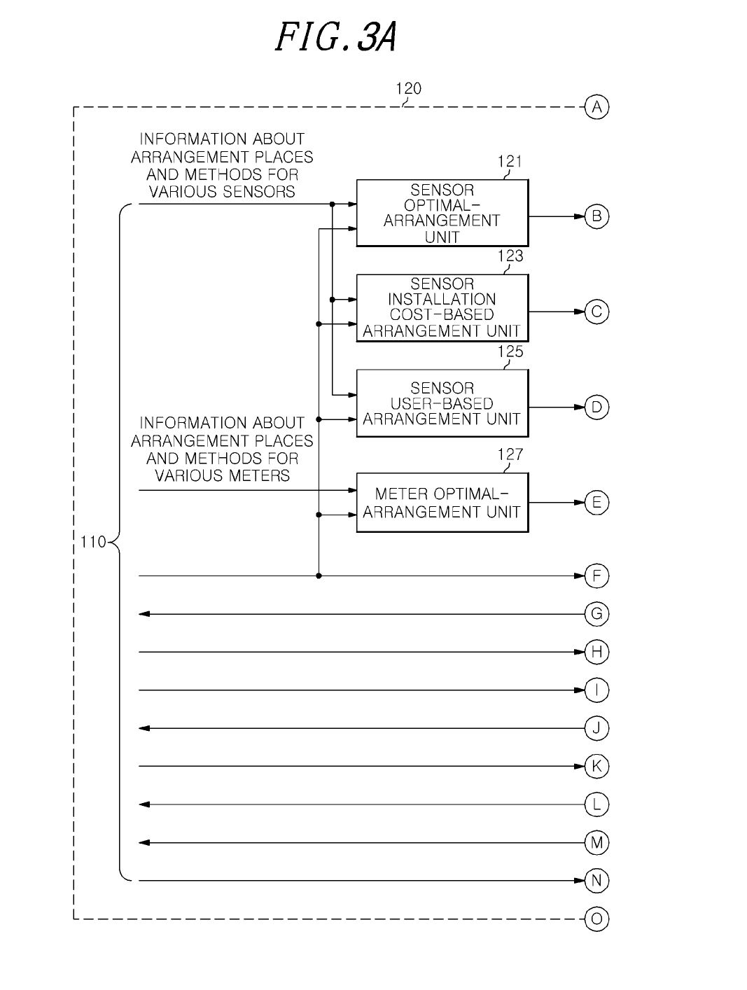

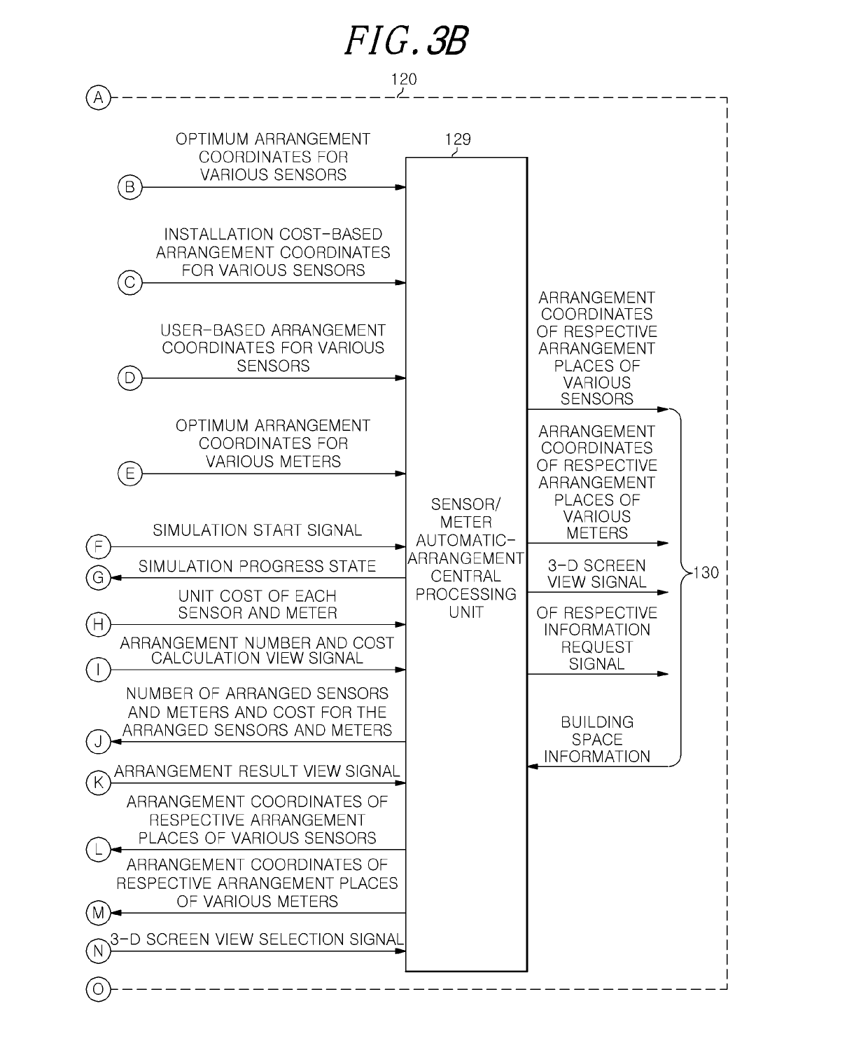

FIGS. 3A and 3B are a detailed block diagram of the sensor/meter automatic-arrangement block 120 shown in FIG. 1. The sensor/meter automatic-arrangement block 120 may include a sensor optimum-arrangement unit 121, a sensor installation cost-based arrangement unit 123, a sensor user-based arrangement unit 125, a meter optimum-arrangement unit 127, and a sensor/meter automatic-arrangement central processing unit 129.

Referring to FIGS. 3A and 3B, when information about arrangement places and methods for the various sensors and a simulation start signal are received from the user interface block 110 of FIG. 1 and an optimum arrangement is selected, the sensor optimum-arrangement unit 121 can provide a function of performing an optimum arrangement for the various sensors and transferring optimum arrangement coordinates for the various sensors, obtained as a result of the optimum arrangement, to the sensor/meter automatic-arrangement central processing unit 129.

When information about arrangement places and methods for the various sensors and a simulation start signal are received from the user interface block 110 and an installation cost-based arrangement is selected, the sensor installation cost-based arrangement unit 123 can provide a function of performing an installation cost-based arrangement for the various sensors and transferring installation cost-based arrangement coordinates for the various sensors, obtained as a result of the installation cost-based arrangement, to the sensor/meter automatic-arrangement central processing unit 129.

When information about arrangement places and methods for the various sensors and a simulation start signal are received from the user interface block 110 and a user-based arrangement is selected, the sensor user-based arrangement unit 125 can provide a function of performing a user-based arrangement for the various sensors and transferring user-based arrangement coordinates for the various sensors, obtained as a result of the user-based arrangement, to the sensor/meter automatic-arrangement central processing unit 129.

When information about arrangement places and methods for various meters and a simulation start signal are received from the user interface block 110, the meter optimum-arrangement unit 127 can provided a function of performing an optimum arrangement and transferring optimum arrangement coordinates for the various meters, obtained as a result of the optimum arrangement, to the sensor/meter automatic-arrangement central processing unit 129.

The sensor/meter automatic-arrangement central processing unit 129 can provide a function of generating a simulation progress state based on a simulation start signal received from the user interface block 110, optimum arrangement coordinates for various sensors received from the sensor optimum-arrangement unit 121, installation cost-based arrangement coordinates for various sensors received from the sensor installation cost-based arrangement unit 123, user-based arrangement coordinates for various sensors received from the sensor user-based arrangement unit 125, and optimum arrangement coordinates for various meters received from the meter optimum-arrangement unit 127 and transferring the generated simulation progress state to the user interface block 110.

Furthermore, the sensor/meter automatic-arrangement central processing unit 129 can provide a function of generating the arrangement coordinates of the arrangement places of various sensors and the arrangement coordinates of the arrangement places of various meters, transferring the generated arrangement coordinates to the BIM-based building model block 130, calculating the number of arranged sensors and meters and a cost for the arranged sensors and meters based on a unit cost of each of various sensors and meters, the number of arranged sensors and meters, and a cost calculation view signal which are received from the user interface block 110, and transferring the calculated number and cost to the user interface block 110.

Furthermore, the sensor/meter automatic-arrangement central processing unit 129 can provide a function of transferring the arrangement coordinates of the respective arrangement places of various sensors and the arrangement coordinates of the respective arrangement places of various meters, generated in response to an arrangement result view signal received from the user interface block 110, to the user interface block 110, generating a 3-D screen view signal in response to a 3-D screen view selection signal received from the user interface block 110, transferring the generated 3-D screen view signal to the BIM-based building model block 130, transferring a building space information request signal to the BIM-based building model block 130, and receiving building space information from the BIM-based building model block 130 as a response to the building space information request signal.

Referring back to FIGS. 1A and 1B, the BIM-based building model block 130 can provide a function of automatically arranging various sensors and various meters in corresponding places (e.g., rooms, floors, and buildings) when the arrangement coordinates of the respective arrangement places of various sensors, the arrangement coordinates of the respective arrangement places of various meters, and a 3-D screen view signal are received from the sensor/meter automatic-arrangement block 120, displaying a sensor/meter arrangement 3-D screen in a building model based on BIM, and transferring building space information to the sensor/meter automatic-arrangement block 120 in response to a building space information request signal received from the sensor/meter automatic-arrangement block 120.

In accordance with the present invention, various sensors necessary to manage building energy and environments are automatically arranged in the rooms, floors, and buildings of a building model based on BIM according to an optimum arrangement, an installation cost-based arrangement, or a user-based arrangement, various meters necessary to manage building energy and environments are automatically arranged in the rooms, floors, and buildings of the building model based on BIM according to an optimum arrangement, the arranged sensors and meters are displayed in a 3-D space, arrangement coordinates for the arranged sensors and meters are displayed, and the number of arranged sensors and meters and a cost for the arranged sensors and meters are calculated and displayed. Accordingly, there is an advantage in that use environment- and object-friendly and flexible BIM can be provided.

While the invention has been shown and described with respect to the preferred embodiments, the present invention is not limited thereto. It will be understood by those skilled in the art that various changes and modifications may be made without departing from the scope of the invention as defined in the following claims.

Accordingly, the scope of the present invention should be interpreted based on the following appended claims, and all technical spirits within an equivalent range thereof should be construed as being included in the scope of the present invention. cm What is claimed is:

1. An apparatus for automatically arranging sensors and meters based on Building Information Modeling (BIM), comprising:
a user interface block for transferring option information and input information for simulations related to an arrangement of various sensors and various meters to a sensor/meter automatic-arrangement block and for displaying information about a simulation progress state and arrangement-related information, received from the sensor/meter automatic-arrangement block, on a screen;
the sensor/meter automatic-arrangement block for generating the information about the simulation progress state by generating optimum arrangement coordinates, installation cost-based arrangement coordinates, and user-based arrangement coordinates for the various sensors and optimum arrangement coordinates for the various meters, generating arrangement coordinates of respective arrangement places of the various sensors, arrangement coordinates of respective arrangement places of the various meters, and a 3-D screen view signal, transferring the arrangement coordinates of the arrangement places of the various sensors and the various meters and the 3-D screen view signal to a BIM-based building model block, calculating a number of arranged sensors and meters and a cost for the arranged sensors and meters, and transferring the calculated number and cost to the user interface block; and
the BIM-based building model block for automatically arranging the various sensors and the various meters in corresponding places of a building based on the received arrangement coordinates of the respective arrangement places of the various sensors, the arrangement coordinates of the respective arrangement places of the various meters, and the 3-D screen view signal, displaying a sensor/meter arrangement 3-D screen in a building model based on BIM, and transferring building space information to the sensor/meter automatic-arrangement block.

2. The apparatus of claim 1, wherein the user interface block comprises:
a sensor/meter arrangement user interface unit for receiving option information about arrangement places and methods for the various sensors, transferring the received option information about the arrangement places and methods for the various sensors to the sensor/meter automatic-arrangement block, receiving option information about arrangement places and methods for the various meters, and transferring the option information about the arrangement places and methods for the various meters to the sensor/meter automatic-arrangement block;
an arrangement simulation user interface unit for receiving simulation start option information, transferring the simulation start option information to the sensor/meter automatic-arrangement block, and displaying the information about the simulation progress state on a screen; and
an arrangement result display user interface unit for receiving information about a unit cost of each of the various sensors and the various meters, transferring the information about the unit cost to the sensor/meter automatic-arrangement block, transferring an arrangement number and cost calculation view signal, an arrangement result view signal, and a 3-D screen view selection signal to the sensor/meter automatic-arrangement block when arrangement result display method option information is received, and displaying the information about the number of arranged sensors and meters, the cost for the arranged sensors and meters, the arrangement coordinates of the respective arrangement places of the various sensors, and the arrangement coordinates of the respective arrangement places of the various meters to the sensor/meter automatic-arrangement block.

3. The apparatus of claim 1, wherein the sensor/meter automatic-arrangement block comprises:
a sensor optimum-arrangement unit for generating the optimum arrangement coordinates for the various sensors by performing an optimum arrangement on the various sensors in response to the information about the arrangement places and methods for the various sensors and the simulation start signal;
a sensor installation cost-based arrangement unit for generating the installation cost-based arrangement coordinates for the various sensors by performing an installation cost-based arrangement on the various sensors in response to the information about the arrangement places and methods for the various sensors and the simulation start signal;
a sensor user-based arrangement unit for generating the user-based arrangement coordinates for the various sensors by performing a user-based arrangement on the various sensors in response to the information about the arrangement places and methods for the various sensors and the simulation start signal;
a meter optimum-arrangement unit for generating optimum arrangement coordinates for the various meters by performing an optimum arrangement on the various meters in response to the information about the arrangement places and methods for the various meters and the simulation start signal; and
a sensor/meter automatic-arrangement central processing unit for generating the information about the simulation progress state based on the optimum arrangement coordinates, the installation cost-based arrangement coordinates, and the user-based arrangement coordinates for the various sensors and the optimum arrangement coordinates for the various meters, transferring the generated information about the simulation progress state to the user interface block, transferring the arrangement coordinates of the respective arrangement places of the various sensors and the arrangement coordinates of the respective arrangement places of the various meters to the user interface block and the BIM-based building model block, calculating the number of arranged sensors and meters and the cost for the arranged sensors and meters, transferring the calculated number and cost to the user interface block, generating the 3-D screen view signal, transferring the generated 3-D screen view signal to the BIM-based building model block, and receiving the building space information from the BIM-based building model block.

4. The apparatus of claim 1, wherein the various sensors and the various meters comprise a plurality of sensors and a plurality of meters for managing building energy and environments.

5. The apparatus of claim 4, wherein the various sensors comprise a temperature sensor, a humidity sensor, an illumination sensor, a presence sensor, and a CO₂ sensor.

6. The apparatus of claim 4, wherein the various meters comprise a power meter and a gas meter.
